(19) United States
(12) Patent Application Publication
(10) Pub. No.: US 2004/0188622 A1
(43) Pub. Date: Sep. 30, 2004

(54) Gas detection device

(75) Inventors: Hisanori Yokura, Chiryu-city (JP); Yasutoshi Suzuki, Okazaki-city (JP); Takahiko Yoshida, Okazaki-city (JP)

Correspondence Address: POSZ & BETHARDS, PLC, 11250 ROGER BACON DRIVE, SUITE 10, RESTON, VA, 20190, US

(73) Assignee: DENSO CORPORATION NIPPON SOKEN, INC.

(21) Appl. No.: 10/806,282

(22) Filed: Mar. 23, 2004

(30) Foreign Application Priority Data
Mar. 26, 2003 (JP) 2003-85711

(51) Int. Cl. G01N 21/35

(52) U.S. Cl. 250/343

(57) ABSTRACT

A gas detection device includes a light source, a light sensor element, and a shield plate arranged in a single package. The shield plate protects the light sensor element from light beams that travel from the light source directly to the light sensor element. The gas detection device further includes a reflector plate arranged so that light beams emitted from the light source are reflected off the reflector plate and travel to the light sensor element. The light sensor element detects a degree of light absorption by gas provided in a space between the reflector plate, the light source, and the light sensor element.

### CROSS REFERENCE TO RELATED APPLICATION

This application is based on and incorporates herein by reference Japanese Patent Application No. 2003-85711 filed on Mar. 26, 2003.

### FIELD OF THE INVENTION

The present invention relates to a reduced size gas detection device.

### BACKGROUND OF THE INVENTION

Needs for detecting gas including carbon monoxide, carbon dioxide, ammonia, moisture, nitrogen monoxide and hydrocarbon increase in recent years. In detection of such gas, an infrared gas detection device is used. The infrared gas detection device detects a specific kind of gas using characteristics of gas that absorbs infrared rays of a particular wavelength.

An example of such gas detection devices is shown in FIG. 2. In this device, gas is inserted into a space between an infrared emitting device 21 and an infrared sensor 22 through air holes 25 of a housing 24. When gas is inserted into the space while the infrared emitting device 21 is emitting infrared rays, the infrared rays of a particular wavelength is absorbed by the gas. By measuring a degree of absorption with the infrared sensor 22 and the electrical circuit 23, a concentration of the gas is determined.

Because the infrared emitting device 21 and the infrared sensor 22 are opposed to each other, the overall size of the device cannot be decreased. Furthermore, lengths of wires between the electrical circuit 23 and the infrared emitting device 21 or the infrared sensor 22 cannot be reduced.

To solve this problem, another gas detection device is proposed in JP-A-9-184803 shown in FIG. 3. In this device, an infrared emitting device and the infrared sensor 32 are contained in a first package 33 and a second package 34 containing, respectively. The first and the second packages 33 and 34 are mounted on an electrical circuit board 35.

Gas is inserted into a space between the infrared emitting device 31, the infrared sensor 32, and a reflector plate 36 through air holes 38 of a housing 37. When gas is inserted into the space while the infrared emitting device 31 is emitting infrared rays, the infrared rays of a particular wavelength is absorbed by the gas. By measuring a degree of absorption with the infrared sensor 32 and the electrical circuit 35, a concentration of the gas is determined. Because the infrared emitting device 31 and the infrared sensor 32 are contained in the separate packages 33 and 34, the device does not provide much effect in terms of reducing its overall size.

### SUMMARY OF THE INVENTION

The present invention therefore has an objective to provide a reduced size gas detection device. A gas detection device of the present invention has a light source and a light sensor element in a single package. The package has a shield plate in its inner space for reducing light beams that directly reach the light sensor element.

The light source and the light sensor element are separately arranged in a single package with the shield plate. Thus, the device can be reduced in size while the light sensor element is protected from light beams that travel from the light emitting device directly to the light sensor element. To ensure proper detection of gas, the light source and the light sensor element are preferably an infrared emitting device and an infrared sensor element.

### BRIEF DESCRIPTION OF THE DRAWINGS

The above and other objectives, features and advantages of the present invention will become more apparent from the following detailed description made with reference to the accompanying drawings. In the drawings:

FIG. 1 is a schematic view of a gas detection device according to the embodiment of the present invention;

FIG. 2 is a schematic view of a gas detection device using infrared rays according to a related art; and

FIG. 3 is a schematic view of an infrared gas analyzer proposed in JP-A-9-184803.

### DETAILED DESCRIPTION OF THE PREFERRED EMBODIMENT

The preferred embodiments of the present invention will be explained with reference to the accompanying drawings.

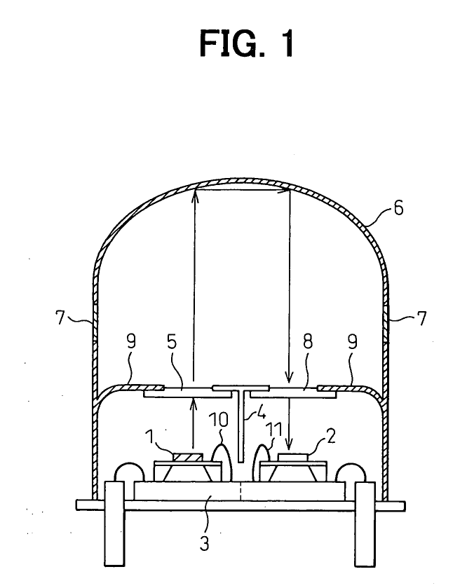

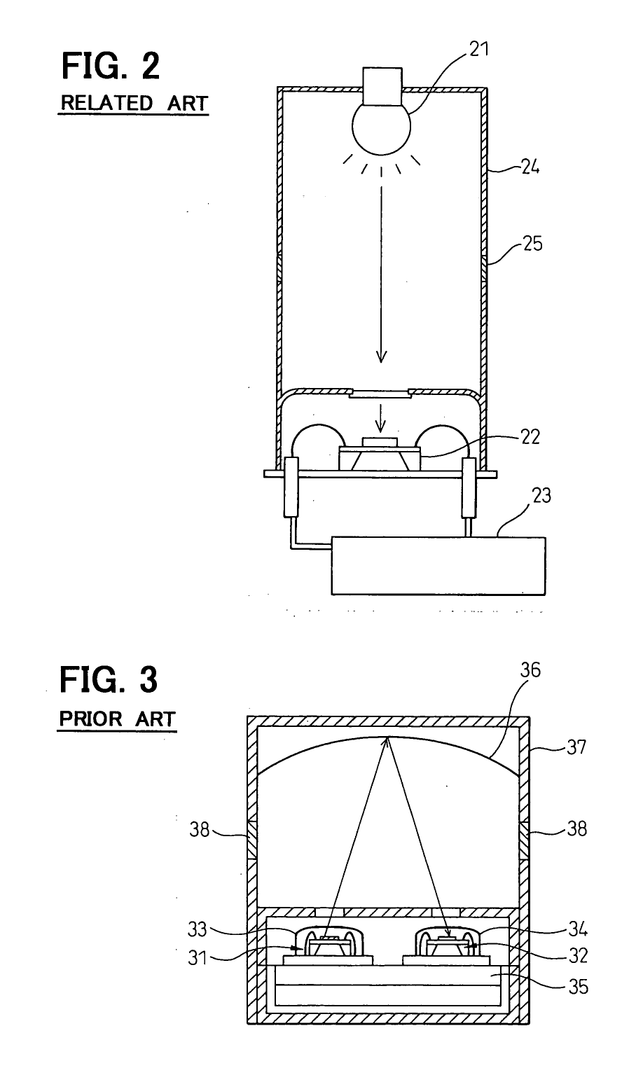

Referring to FIG. 1, a gas detection device of the present invention includes an infrared emitting device 1, an infrared sensor element 2, a circuit chip 3, a shield plate 4, an infrared emitter window 5, a reflector plate 6, air holes 7, a band-pass filter 8, and a package 9. The emitting device 1 is a light source, and the sensor element 2 is a light sensor element. The shield plate 4 reduces infrared rays (light beams) that directly reach the sensor element 2 traveling from the emitting device 1.

The emitter window 5 is a window of the package 9 provided for passing infrared rays emitted from the emitting device 1 to the reflector plate 6. The reflector plate 6 is arranged so that the infrared rays are reflected off the reflector plate 6 and travel to the sensor element 2. The band-pass filter 8 is an infrared sensor window for passing infrared rays of a predetermined wavelength among the infrared rays reflected off the reflector plate 6.

The emitting device 1, the sensor element 2, and the shield plate 4 are housed in the package 9. Infrared rays that are emitted from the emitting device 1 and reflected off the reflector plate 6 travel to the sensor element 2. Gas is inserted into a space between the reflector plate 6, the emitting device 1, and the sensor element 2 for measurement. The sensor element 2 detects a degree of absorption of the infrared rays by the gas.

The emitting device 1 and the sensor element 2 are mounted on the circuit chip 3 and connected with the circuit chip 3 via wires 10 and 11. The emitting device 1 controlled by circuit elements included in the circuit chip 3 emits infrared rays when heated by a heater (not shown). The infrared rays emitted from the emitting device 1 are blocked by the shield plate 4 so that they do not directly travel to the sensor element 2. The infrared rays travel to the reflector plate 6 through the emitter window 5 and to the sensor element 2 after reflected off the reflector plate 6. The reflector plate 6 is optically designed to effectively guide the infrared rays to the sensor element 2.

The infrared rays reflected off the reflector plate 6 are filtered by the band-pass filter and the infrared rays of the predetermined wavelength are passed into the package 9. The infrared rays of the predetermined wavelength only reach the sensor element 2 and an intensity of the infrared rays is measured by the sensor element 2. The predetermined wavelength is set to 4.26 μm for detecting carbon dioxide gas.

An atmosphere of gas is inserted in a space between the package 9 and the reflector plate 6 via the air holes 7. If the atmosphere does not exist in the space, all infrared rays reach the sensor element 2. However, if the atmosphere exists in the space, the infrared rays are absorbed into the atmosphere by the amount corresponding to the concentration of the gas. As a result, the amount of infrared rays that reach the sensor element 2 is reduced, namely, the intensity of the infrared rays is decreased. The sensor element 2 detects a degree of absorption of the infrared rays by the gas based on the decrease in intensity of the infrared rays. The amount of the gas is determined based on the reduced amount of the infrared rays or the concentration of the gas is determined based on the degree of absorption of the infrared rays.

In the above configuration, the emitting device 1 and the sensor element 2 are arranged in the single package 9. Thus, the overall size of the gas detection device is significantly reduced in comparison with the gas detection device shown in FIG. 3. Furthermore, the infrared rays are filtered for the predetermined wavelength and precisely guided to the detection device 2. As a result, a specific kind of gas can be properly detected.

The present invention should not be limited to the embodiment previously discussed and shown in the figures, but may be implemented in various ways without departing from the spirit of the invention. For example, the predetermined wavelength may be set to a wavelength at which carbon dioxide gas does not absorb the infrared rays, such as 3.4 μm and 4.0 μm, for increasing accuracy of the gas detection device. The emitting device 1 and the sensor element 2 may be mounted on separate circuit chips.

To detect other kinds of gas, the wavelength that band-pass filter 8 passes through is set to the wavelength of the infrared rays absorbed by the gas. The band-pass filter may be provided for the infrared emitter window 5 or for both the infrared emitter window 5 and the infrared sensor window 8.

What is claimed is:

1. A gas detection device comprising:
a light source for emitting light beams;
a light sensor element for sensing the light beams emitted from the light source;
a shield plate for reducing light beams that directly reach the light sensor element;
a package for housing the light source and the light sensor element; and
a reflector plate arranged for reflecting light beams emitted from the light source to the light sensor element, wherein
the package houses all of the light source, the light sensor element, and the shield plate, and
the light sensor element detects a degree of light absorption by gas provided in a space between the reflector plate, the light source and the light sensor element.

2. The gas detection device according to claim 1, wherein:
the light source is an infrared emitting device; and
the light sensor element is an infrared sensor element.

3. The gas detection device according to claim 1, wherein the package has a light source window for passing light beams emitted from the light source to the reflector plate and a light sensor window for passing light reflected off the reflector plate to the light sensor element.

4. The gas detection device according to claim 3, wherein at least one of the light source and the light sensor windows has a band-pass filter for passing only light beams of a predetermined wavelength.

5. The gas detection device according to claim 1, wherein the light source and the light sensor element are mounted on a single circuit chip.

6. The gas detection device according to claim 1, wherein the light source and the light sensor element are mounted on separate circuit chips.
